(19) United States
(12) Patent Application Publication
(10) Pub. No.: US 2003/0025072 A1
(43) Pub. Date: Feb. 6, 2003

(54) Distributed fiberoptic sensors

(75) Inventor: Jennifer J. Zinck, Calabasas, CA (US)

Correspondence Address: Richard P. Berg, Esq., c/o LADAS & PARRY, 5670 Wilshire Boulevard, Suite 2100, Los Angeles, CA, 90036-5679, US

(73) Assignee: HRL Laboratories, LLC

(21) Appl. No.: 09/923,731

(22) Filed: Aug. 6, 2001

(51) Int. Cl. G01J 4/00

(52) U.S. Cl. 250/227.18

(57) ABSTRACT

A distributed fiberoptic radiation sensor is described which may employ one or more radiation sensor elements distributed in a single optical fiber. Such optical fibers may be placed on surfaces, or even within parts, to unobtrusively measure radiation in precise and even difficult to reach locations. Different sensor elements may respond to different radiation types and wavelength ranges, with each sensor element causing a different wavelength of light to be emitted or absorbed within the fiber. By employing an appropriate combination of detection methods at the ends of the fiber, the distributed sensor may provide type and calorimetric discrimination of radiation incident on one or more distinguishable locations. The radiation information thus detected may be integrated, if desired, to obtain corresponding real-time dose information. With such integration, the device becomes a distributed real-time dosimeter. In another embodiment, the particular radiation sensors distributively employed may undergo permanent change in absorption characteristics. Such a device infers a total radiation dose over a particular period by measuring a change in optical response between the beginning and the end of the particular period.

### I. BACKGROUND OF THE INVENTION

1. Field of the Invention

The present invention pertains to sensing devices, particularly sensing devices based upon fiber optic sensors.

2. Description of the Related Art

Sensing devices are pervasive today, providing the input from the physical world that enables computing power to be harnessed directly to automatically control physical processes and environments. The present invention has application in at least two kinds of sensing: radiation sensing and material presence sensing.

Radiation sensors, as the name implies, sense radiation impinging on a particular locale. Sensing is typically limited to a particular type of radiation, such as γ- or β-radiation, and to a particular frequency or energy range. Some radiation measuring devices provide information about a present radiation rate or intensity; dosimeters, on the other hand, typically provide information about the total radiation encountered over a given period of time. The two types of measuring devices are related, since integrating the radiation intensity over a period provides the dose over that period, while the rate of increase of dose indicates radiation intensity, so that intensity may be determined by differentiating the measured dose. The present invention may be practiced to provide both intensity and dose information.

Radiation measurement is useful for a wide range of purposes. For example, it is important to track the exposure of organisms and structures to harmful radiation in order to avoid excessive risk of damage, and useful to ensure adequate exposure to kill harmful bacteria in food.

Many manufacturing processes utilize radiation. In particular, composite materials may be molded into parts having complex shapes, and the molding resin may be cured by exposure to radiation, such as β-, or electron beam (e-beam) radiation. In order to properly control the rate and completeness of curing, it is useful to determine the rate, and particularly the dose, of radiation to which the parts are exposed.

When molded parts having complex shapes are cured using e-beams, edges of the part may cause shadowing and incomplete exposure of areas of the part, resulting in irregular or incomplete curing of the part. This problem has been addressed in the past by applying thin-film dosimeters, which are either calorimetric or radiochromic, to the part. These devices are typically placed at specific locations on the surface of the part, absorb radiation during curing, and then are analyzed for total exposure dose at the dosimeter location in a post-processing step after the curing process is completed. The radiation curing process may then be adjusted to deliver a different amount of radiation to the next batch of parts.

However, this approach does not provide real-time dose information indicating exposure as it occurs, and thus cannot ensure that each current batch of parts is correctly cured. Accordingly, a need exists for a radiation sensor which can measure radiation in real time in order to provide information to ensure correct curing of each batch of molded parts.

Moreover, in processing radiation-cured molded parts, it has been necessary to remove such thin-film dosimeters for post-processing analysis. That necessity generally makes it impractical to embed sensors inside the parts to determine radiation dose there, because retrieving the sensor would require destruction of the molded part. Accordingly, an ideal radiation sensor would not only readily fit the shapes needed for complex molded parts, but would also permit measurement inside a part, and would permit real-time intensity and/or dose measurement.

Another problem involved in molding complex parts is ensuring that the molding resins penetrate fully into the mold, so that the finished part does not have gaps. Compromises of the part design may be necessary to ensure reliable resin penetration. Thus, a need exists for a sensor which can indicate the presence or absence of a material. Ideally, such a sensor would be readily located within complex molds to indicate that the injected molding material has penetrated fully.

Fiberoptic radiation sensors are known in prior art. For example, optically stimulated luminescence sensors (Luxel® OSL Dosimeters) are produced commercially by Landauer, Inc. of Glenwood, Ill. These devices contain aluminum oxide which responds to cumulative radiation exposure by becoming luminescent under laser stimulation. An optical fiber is used to conduct the stimulating laser signal to the aluminum oxide. However, such an approach does not permit radiation measurement at a plurality of locations using a single fiber, and indeed does not permit radiation measurement along the length of a fiber. Other fiber optic sensors are known. For example, U.S. Pat. No. 5,359,681 to Jorgenson et al. describes use of a modified optical fiber to provide Surface Plasmon Resonance (SPR) sensors at locations along the modified optical fiber. This requires a SPR-supporting metal layer to be applied to an exposed optical fiber core in the sensor locations. In addition, this sensor does not sense radiation, and does not suggest a method for identifying completion of contact.

Therefore, a need exists for a radiation sensor which:

(a) can be disposed within a curing part;

(b) can measure radiation in real time;

(c) can be used to sense radiation in and around complex shapes; and

(d) can sense a range of radiation types and wavelengths.

A need exists, as well, for a multi-purpose sensor capable of sensing a variety of different phenomena at a single location or at different locations along a sensing optical fiber. The present invention provides such a sensor.

### II. SUMMARY OF THE INVENTION

Devices according to the present invention may achieve the desired functionality, and also have further advantages. Sensors according to the present invention are formed of very thin optical fiber, and readily fit many shapes needed for complex molded parts. Individual sensor fibers, with the appropriate sensing electronics to interpret the results, can sense one or more types of radiation at one or more regions of the single fiber. In some embodiments, radiation may be qualitatively indicated by direct optical output laterally from the sensor.

Devices according to the present invention may measure accumulated dose of radiation received, or may indicate an instantaneous radiation intensity at one or more sensor regions, or may indicate the presence of material in contact with the sensor. An important aspect of the present invention is the ability to distribute combinations of these various types of sensing along an optical fiber.

In a preferred embodiment, the invention is employed with a molding process in which radiation is used to cure the molding resins. Sensor fibers according to the present invention may be woven inside a part to be molded, or included in the layup for the part, and may thus permit measurement inside, or at difficult-to-reach locations around, the part being molded. Indeed, a sensor fiber according to the present invention may often be left inside a part after processing is completed without adversely affecting the part.

Such sensors may be used first to indicate the proper distribution of molding resins, and may subsequently indicate, in the same part, that sufficient radiation has reached the resin to assure that it is fully cured. Finally, such a sensor permits real-time radiation intensity and/or dose measurement, which enables immediate correction of the dose applied to a current batch of parts.

Other advantages of devices according to the present invention will become apparent from the description of the preferred embodiments represented hereinbelow. Some of these advantages comprise an ability to use a single device to independently measure radiation which is distinguished as to type, frequency and/or location, and an ability to measure an accumulated dose of such radiation in real-time without constant monitoring. In some embodiments a single sensing region may first sense material presence, and thereafter sense radiation.

The present invention employs a fiberoptic fiber which is modified at one or more regions along its length such that, at each region, the optical properties of the modified fiber region are modulated by contact, or by either instantaneous or cumulative exposure to radiation.

One or more of different types modifications may be employed, in a variety of combinations, with one or more modified sensor regions distributed at one or more locations along a single contiguous fiber, to form the sensor fiber for various embodiments of the present invention. Differing sensor regions may be combined in a single fiber either by treating regions of an originally contiguous fiber, or by splicing special fiber sections into the sensing fiber, or by a combination of these. At least some embodiments of the present invention thus distribute a plurality of sensing elements having different sensing qualities at selected locations along a single sensing fiber.

In a first type of modification, a fiber core contains elements which are persistently ionized by exposure to radiation. The ionized species will then either emit or absorb radiation at specific wavelengths upon stimulation.

In a second type of modification, a fiber core is doped with elements which transiently emit radiation at specific wavelengths in response to stimulation by radiation.

In a third type of modification, the optical fiber cladding is removed from the fiber at sensor locations, and a thin film of sol-gel glass (either doped or undoped) is coated on the core. According to this method, the particular sol gel glass used at each location may be differently doped, and thus will have a different emission characteristic.

In a fourth type of modification, the optical fiber cladding is removed from the fiber at sensor locations, and a material is disposed around the core which changes its optical properties as a function of cumulative exposure to radiation. In a preferred embodiment of this type of modification, the material may be a resin which is being cured into a mold by exposure to e-beam radiation.

In a fifth type of modification, the optical fiber senses the presence of material disposed around it. In a preferred embodiment cladding is removed from the fiber at sensor locations, and the core is not covered. If certain materials then move to contact the core, the core losses during light transmission will be modulated accordingly. Moreover, the same region may subsequently indicate radiation exposure dose. The optical properties of these material coatings continue to be changed by the extent of curing of the material, and thus, as radiation curing proceeds, the transmission of light through the sensing fiber is further modulated by the level of curing of the material.

In each of the first, second and third modifications above, a single dopant may be used in a given sensing region, or a plurality of different dopants having different emission characteristics may be used. When using a plurality of dopants, the selection and concentration of dopants used at each sensing region may be different, and thus each sensing region can be distinguished by having a different emission characteristic.

The primary fiber, modified as described in one or more regions distributed along its length, is positioned such that the appropriate sensing portions of the fiber intercept the phenomena to be measured. The emission and absorption of light along the entire fiber, at appropriate wavelengths, is then monitored to sense the effects of the radiation on the sensor regions. Depending on the radiation to be sensed, interpretation of the sensor information requires one of the following:

(1) without providing an optical test signal, sensing an output from the ends of the sensor fiber of particular wavelengths of light produced by the elements disposed in one or more sensor regions, thereby indicating presence of radiation exposure at the sensor regions stimulating the emission;

(2) directing a known optical test signal through the sensor fiber at particular frequencies, and measuring the output at the other end of the fiber to evaluate the losses through the fiber incurred by the test signal; or

(3) directing a known optical test signal through the sensor fiber, and examining light escaping laterally from the sensor fiber at the sensor regions, either visually or by means of a sensor sensitive to the escaping light.

Thus, by distributing sensors along a fiber, which are responsive to different radiation to emit characteristic photons, or to accumulated radiation, or the presence of material to change conductive qualities, or the presence of a combination of materials, present radiation intensity and/or accumulated radiation dose may be measured at a variety of regions along the fiber, for a variety of materials, radiation types and energies.

### III BRIEF DESCRIPTION OF THE DRAWINGS

FIG. 1 shows sensing regions distributed along a fiber of a sensor system.

FIG. 2 shows a part to be molded with sensor fibers in the mold form.

FIG. 3A shows a fiber sensor region having a doped core.

FIG. 3B shows the response of the sensor of FIG. 3A under irradiation.

FIG. 4 shows a fiber core coated with doped sol-gel glass.

FIG. 5A shows an exposed fiber core being contacted by molding resins.

FIG. 5B shows the response of a FIG. 5A sensor to progressive resin contact.

FIG. 6A shows a fiber core coated with radiation sensitive resin.

FIG. 6B shows the response of a FIG. 6A transmission loss sensor under irradiation.

### IV. DETAILED DESCRIPTION OF THE INVENTION

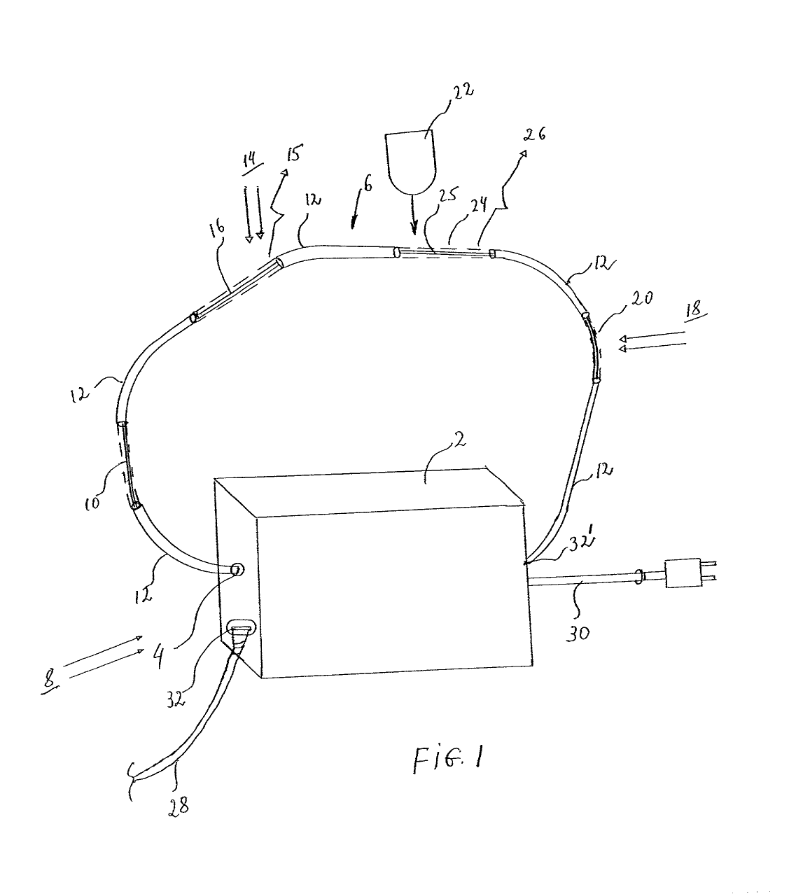

FIG. 1 represents a distributed radiation sensor according to the present invention. Optical drive and receive unit 2 is controlled by a computer (not shown) via cable 28, for example, a USB connector, which is plugged into cable connector 32, for example, a USB connector. Of course, any interface to a controlling computer may be used, and the unit may be composed of separate subsections which perform the same function. Power for unit 2 is provided by power cable 30. Optical fiber connector 4 connects to an optical fiber, which in this case is sensing fiber 6. Native portions 12 of optical fiber 6 are unmodified, and may, for example, be commercially available silica fiber which transmits light directed therethrough with minimal losses. Native portions 12 have at least one layer of cladding, and may have either a single-mode or multi-mode fiber core.

First radiation sensing region 10 may be defined as a “core dosimeter” region. Sensing region 10 may be modified as part of fiber 6, or may be a separate sensing section which is spliced into fiber 6. The core of sensing region 10 comprises one or more of radiation sensitive material, dopants, F-centers and color centers, which upon exposure to appropriate radiation 8 are ionized or otherwise modified. The response to radiation is at least reasonably persistent, so that the quantity of modified material is a predictable function of the cumulative dose of radiation absorbed.

The constituents, once ionized, affect the response of the region to a test light transmission. For example, core fiber, preferably manufactured of silica, is modified by doping, preferably by ions such as Tb³⁺, Eu³⁺, Er³⁺, or Pr³⁺, or similar dopants. These dopants are also preferred dopants for other, subsequently discussed, sensing regions wherever this application teaches use of dopants.

The core fiber so modified emits photons at a first wavelength. This applies both to this sensing region and for other sensing regions subsequently discussed. For example, in case of Tb³⁺ as a dopant, it emits within a range of wavelengths of between about 400 nanometers and 600 nanometers, when exposed to corresponding radiation 8, within a range of wavelengths between about 200 nanometers and 400 nanometers. In case of Eu³⁺ as a dopant, the core fiber emits within a range of wavelengths of between about 600 nanometers and 700 nanometers, when exposed to corresponding radiation 8, within a range of wavelengths between about 350 nanometers and 400 nanometers.

These emissions may be monitored by a light sensing apparatus (not shown) at the receiving end 32′ of the optical drive and receive unit 2. A further piece of native fiber 12 connects first sensing region 10 to second radiation sensing region 16, which may be defined as an “emissive coating sensor.” Second sensing region 16 is stripped down to the core of fiber 6, which is then coated with a first sol-gel coating containing one or more alkali halide color centers.

The alkali halides comprise commercially available LiF, NaF, KF, chlorides of all five alkali metals, and bromides and iodides of all alkali metals except lithium. Upon exposure to appropriate radiation 14, these color centers emit light of a particular wavelength. For example, using NaCl color centers in the sol-gel glass coating, radiation having energy of about 2.67 eV will cause emission of light having a wavelength of about 465 nanometers.

Although these emissions are generated outside the core of the optical fiber 6, a proportion will be conducted inside the fiber and may be monitored by the light sensing apparatus at the receiving end 32 of optical drive and receive unit 2. Because the emissions are not fully contained within fiber 6, escaping light 15 also indicates the radiation exposure. Escaping light 15 can be observed either visually or by a sensor located adjacent the first sol-gel sensor region.

Following another interconnecting section of native fiber 12, third sensing section 24 has a fiber core 25 which has been stripped of cladding layers to form said third sensing section 24 which may be defined as a “material presence sensor” 24. As a material 22 moves into contact with stripped fiber core 25, low refraction index air is replaced with material 22, which will cause light transmitted through core 25 to suffer transmission losses. The exact type of losses depend upon the material 22, which may be conductive of light but at a higher refraction index than core 25, or may be less conductive, or even opaque. A test light signal at a wavelength which will not interfere with other measurements is then directed by optical drive and receive unit 2 into sensing fiber 6 at connector 4, and received by unit 2 at receive connector 32. By monitoring the losses to the light conducted through sensing fiber 6, substantial information about the contact between material 22 and core 25 can be deduced.

In a preferred embodiment, material 22 may be a molding resin, and sensing region 24 may serve a double function. First, it can be used to indicate when the molding resin has contacted the sensing region along its length. Curing e-beam radiation may be started thereafter; and because the optical properties of the resin change as it cures, sensing region 24 may also indicate when sufficient radiation dose has been applied in the region of the sensor.

Various materials, like radiation-curable molding resins, change optical properties as a function of their total exposure to radiation. Therefore, sensing region 24 may be fully coated with such a material 22, and by monitoring losses through fiber 6, the cumulative radiation delivered to material 22 can be determined. This embodiment of a sensing region, which may be defined as a “cladding mismatch sensor,” thus measures the cumulative dose. This embodiment is preferable when total dose is desired, because calculation is greatly simplified compared to measuring and integrating the radiation rate to determine total dose, and is particularly convenient for radiation curing of certain resins.

Since material 22 causes light to escape from core 25, direct visual observation or measurement with an adjacent light sensor may in some cases be used to determine the extent of contact between material 22 and core 25. Similarly, once a transparent material 22 is disposed around core 25, the radiation dose may be determined by lateral observation of the light 26 escaping core 25, either visually or using a light sensor to measure the quantity of escaping light 26.

Further sensing region 20 has a sol-gel covering the core of fiber 6. Upon exposure to radiation, sol-gels doped with the previously discussed dopants, will begin to absorb light at certain wavelengths which is propagating along sensing fiber 6. By determining losses to conducted light at these certain wavelengths, the quantity of radiation 18 which has been absorbed by sensor region 20 can be determined independently of the radiation absorbed by sensing region 24. These sensor sections may be called “absorptive color center sensors.”

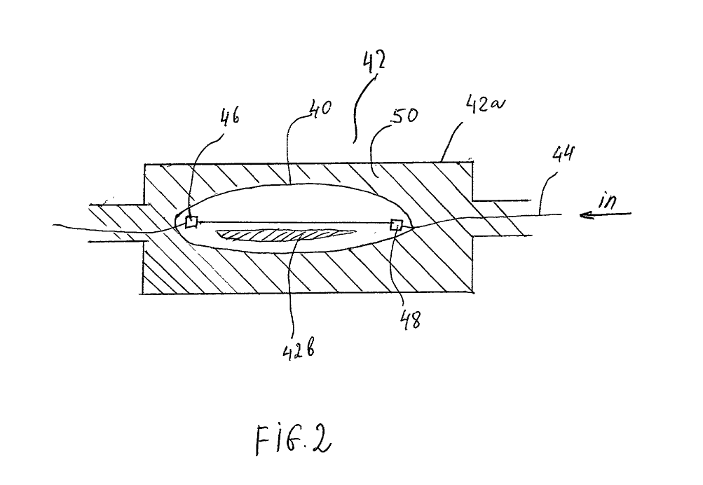

In FIG. 2, molding form 42 (comprising an outer mold 42a and an inner mold or tool 42b) includes sensor fiber 44 with sensor regions 46 and 48. The irregularity of molded part 40 prevents certainty as to the distribution of composite resin 50, and also as to the amount of radiation reaching the resin. Sensors in accordance with the present invention address this problem.

Sensor region 46 is expected to be the last area reached by molding resin 50, and will indicate when it is being covered by resin 50. Emissions will escape from fiber 44 at sensor region 46 where it is in contact with molding resin 50, which escaping light may be detected visually or by independent light sensors. The amount of light lost in the sensing region can also be deduced by measuring the losses to light conducted through fiber 44.

The optical properties of resin 50, after it covers sensor region 46, will be modulated by the accumulated radiation dose which resin 50 has received in this region, causing the proportion of light escaping the sensing fiber in that region to change. By providing a light source directed into the core of sensing fiber 44, light escaping at sensor region 46 may be observed visually or measured by adjacent sensors. The losses to light conducted via sensor fiber 44 may also be calculated, and the radiation absorbed by resin 50 determined therefrom. In a preferred embodiment, a composite molding resin is used, preferably, an epoxy, a polyimide, a bismaleimide, or a cyanate ester resin, and is cured by exposure to electron beam (e-beam) radiation. Thus, after sensing region 46 has been completely covered with resin, it becomes an e-beam dosimeter region.

Sensor region 48 will provide emissions in response to instantaneous radiation which it is absorbing. As the emissions are not all contained within sensing fiber 44, they may be visually observed, or measured by an independent sensor adjacent sensor section 48. However, some of the emissions will remain in sensor region 48 and can therefore be detected at the optical receiver (not shown) as an indication of current radiation intensity levels being absorbed by sensor region 48.

When the mold is opaque, sensor regions 46 and 48 of sensor fiber 44 function much as they do in FIG. 2. However, as the sensor is embedded within the part, visual observation of radiation-induced emissions, or of light escaping the core, will be obscured by the mold form 42 or even by the molding resin, unless the resin of the entire part is transparent to the wavelengths of interest. Accordingly, measurement of emissions from sensing region 48, or of losses caused by sensing region 46, will usually be measured only by the optical drive and receive unit (not shown).

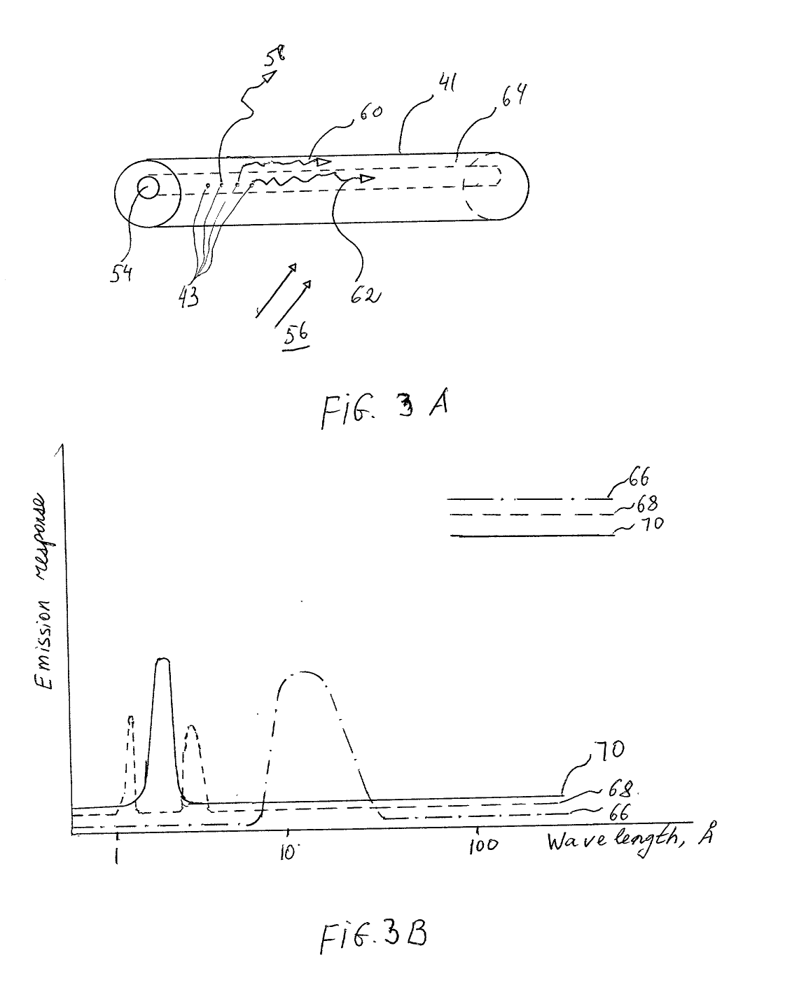

FIG. 3A shows a doped-core sensing region 41 of a sensing optical fiber. Core 54 is doped with dopant 43, selected from the group of dopants identified hereinabove, according to the needs of the application and in accordance with selection criteria known to those skilled in the art. A plurality of dopants can be used in the same sensor region, or in different sensor regions.

When irradiated by appropriate radiation 56, the dopants emit photons, such as 58, 60, and 62 at characteristic wavelengths. Some will be emitted, like 58, at an angle which causes them to be entirely lost from the sensing optical fiber. Some, like 60, will be emitted at an angle which will cause them to propagate within cladding layer 64. Photons like 62 will propagate within the core of fiber 41. These emissions may thus be measured: photons 58 may be detected visually if cladding 64 is transparent, and photons 62, and to some extent 60, may be measured at an end of the sensing optical fiber.

FIG. 3B shows the emission response of three typical dopants, selected from the group of dopants identified hereinabove, to γ-radiation 56 of a given intensity. Dopant I, identified as numeral 66, for example, responds broadly to γ-radiation between about 9 Angstroms and about 40 Angstroms in wavelength; dopant II, identified as numeral 70, has a single response peak at about 4 Angstroms; and dopant III, identified as numeral 68 shows a two peak response to γ-radiation at about 2 Angstroms and at about 6 Angstroms. Once the dopants are selected according to the radiation for which sensing is desired, it is a simple matter to calibrate the receiving device to determine the radiation intensity of radiation 56.

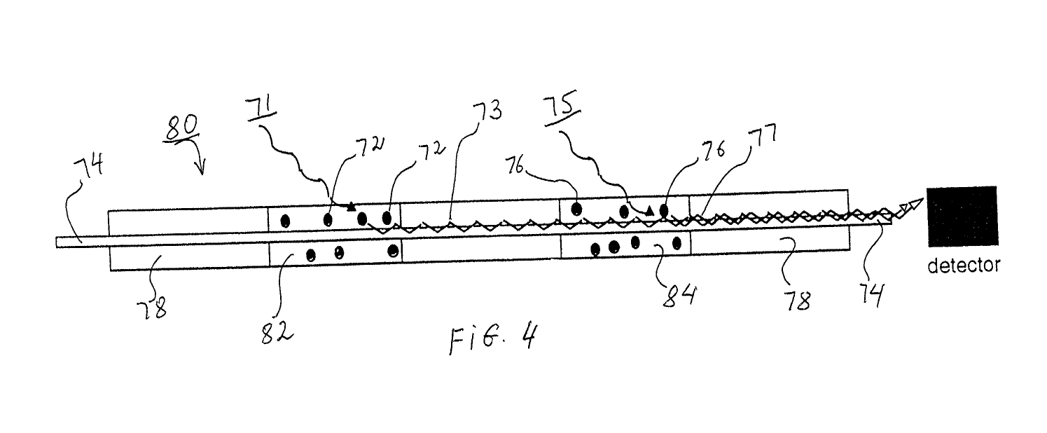

FIG. 4 shows two sections of sol-gel emissive detector, which function similarly to a doped-core sensing region described above. Emissive dopants 72, 76 are introduced into sol-gel glass 82, 84 which is disposed about core 74 of sensing fiber 80 where normal cladding layer 78 has been stripped away. Exposed to appropriate radiation 71, dopant 72 of sol-gel glass region 82 will emit a photon 73 at a characteristic wavelength. Similarly, other dopants 76 of sol-gel glass region 84 will emit a photon 77 in response to absorbing appropriate radiation 75. Enough of the emitted photons 73, 77 will be retained within sensing fiber 80 to permit measurement of the quantity of produced radiation at a detector at an end of sensing fiber 80.

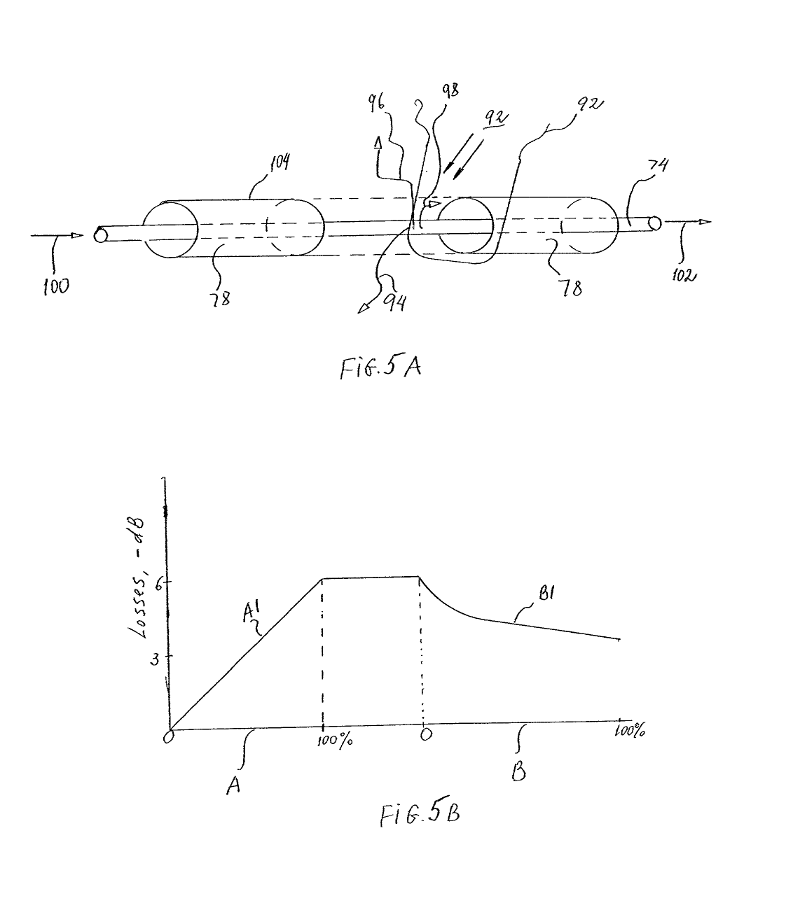

FIG. 5A shows a section of a sensing fiber 104, cladding layer 78 being stripped off in the sensing region. A light signal 100 is being transmitted along sensing fiber 104 and enters the sensing region. Light signal 102 leaving the sensing region will be measured for losses compared to incoming signal 100. Material 92 is coming into contact with the bare core 74 of the sensing region, causing escape of light from core 74. If material 92 is opaque to light in signal 100, then escaping light 94 will be visible at the point of interference between material 92 and core 74, while other escaping photons 98 will be absorbed by material 92. If material 92 is transparent to light in signal 100, then escaping photons 96 will also be visible, and can be measured if desired by a nearby detector. Core 74, in the sensing region where cladding 78 is stripped off, is preferably entirely surrounded by air, or another displaceable fluid which has a suitable low index of refraction to keep losses to a minimum in the absence of physical interference.

FIG. 5B shows the amplitude of exiting light signal 102, compared to incoming light signal 100, as a material 92, preferably, a molding resin, moves from no contact with core 74 to completely covering the portion of core 74 which is exposed in the sensing region. Such movement of material 92 is reflected on portion A of FIG. 5B, where no contact, initial moment is 0% and the moment of complete covering is 100%.

An important point about these losses, indicated on the Al portion of the curve of FIG. 5B, is that they occur across a fairly wide range of wavelengths of optical signals 100. This will ultimately permit the optical contribution due to contact by material 92 to be separated from absorption losses at specific wavelengths in other sensor regions.

FIG. 5B also shows the effect, for a particular material 92 which is preferably a composite resin for molding purposes, as e-beam curing is commenced. This effect is demonstrated on portion B of FIG. 5B, where the degree of curing is between 0 and 100%.

The optical properties of the resin covering core 74 in the sensing region are modulated by the curing, such that much of the transmissivity of sensing fiber 104 is recovered by the completed curing of the resin, as shown on the B1 portion of the curve of FIG. 5B. Because cumulative exposure to radiation effectively modulates the index of refraction of certain materials, such as the resin described above, increased radiation will cause such material, when disposed around an optical fiber core transmitting light, to modulate the losses of light being conducted through the optical fiber.

Because the losses are due to optical mismatch of the core and “cladding,” they are fairly broadband and can thus be distinguished from wavelength-specific absorptive loss sensors.

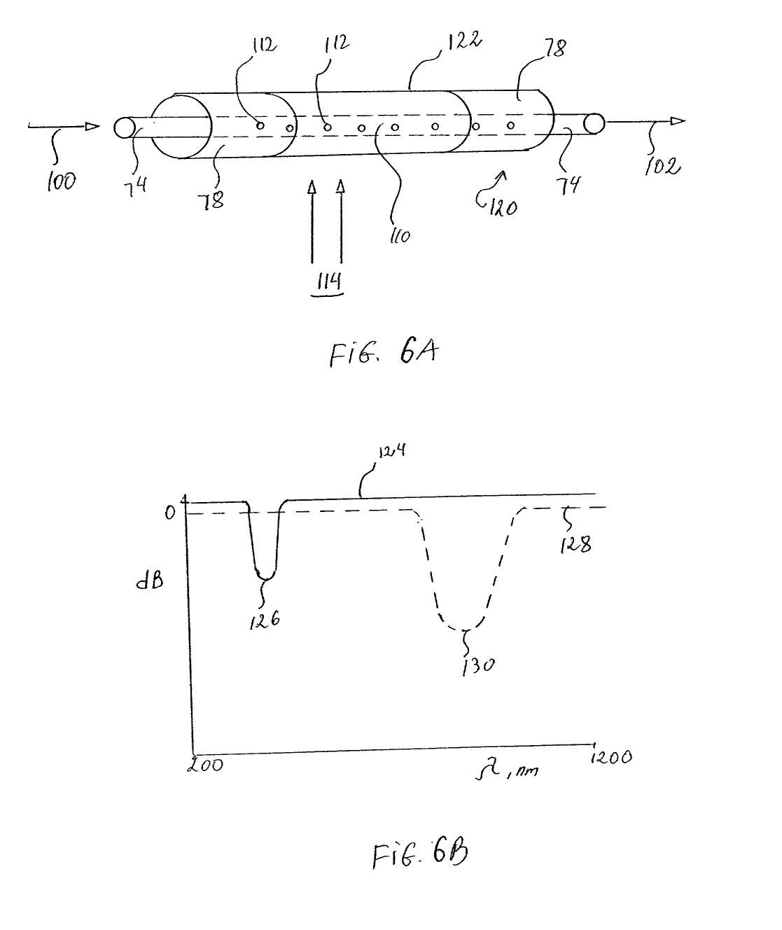

FIG. 6A shows sensing region 122 spliced into sensing fiber 120, with incoming optical signal 100 and outgoing optical signal 102. Dopants 112 in doped core 110 of sensing region 122 are permanently modified by exposure to radiation. When so modified, they absorb light at a specific wavelength. A single dopant 112 is described, but other dopants behave similarly except they may absorb light at different wavelengths. Since the modification is permanent, the total integrated dose of radiation 114 absorbed by all the dopants 112 in sensing section 122 can be deduced by the losses which light signal 100 suffers before emerging as residual light signal 102.

FIG. 6B shows the transmissivity of fiber sensing section 122 as a function of wavelength for two typical dopants 124, 128 (selected from the group of dopants identified hereinabove) which have been exposed to radiation to which they are sensitive. The absorption peak 126 at a first wavelength is a predictable function of the total radiation exposure for dopant 124, the length of sensing section 122, and the quantity of dopant present in sensing section 122. Similarly, absorption peak 130 at a second wavelength range is a predictable, and separate, function of integrated radiation exposure of sensing section 122 having a given quantity of second dopant 128. Since these absorption peaks do not affect significant bands, such sensing sections can each employ a different dopant, and the individual effect determined irrespective of other sections, and irrespective of a broadband loss-inducing sensor section as described with respect to FIGS. 5A and 5B.

Those skilled in the art will be able to discriminate between the superimposed optical effects of a variety of sensor sections spliced into a single fiber, as described above, particularly if they measure as follows. First, a loss spectrum should be measured for the sensing fiber. Losses will (typically) be partly broadband, which can be tested using test light of any wavelengths unaffected by more wavelength-specific absorptive regions. The remaining wavelength-specific losses can be discriminated by adding back an amount equal to the predicted broadband losses at each wavelength.

Next, the emissions from emissive sensors can be measured at their specific wavelengths, with allowance made for any absorptive sensors which absorb in the particular emissive wavelength being considered. Care is required, of course, not to create a sensor fiber with emissive or absorptive responses to radiation which cannot be distinguished from each other. If substantial sensor complexity is desired, it may be useful to dispose optical receivers at both ends of the sensing fiber when a test signal is not being transmitted, to avoid some absorptive sections.

Visual observation of the sensing system will permit many qualitative evaluations of radiation presence and accumulated dose.

The present invention has been described in exemplary embodiments. An important aspect of the present invention is its ability to distribute sensing elements along an optical fiber. One type of sensor may be distributed in many places, or many types of sensors may be distributed along the fiber. The combinations of sensors according with the present invention are accordingly extremely numerous.

Having described the invention in connection with several embodiments thereof, modification will now suggest itself to those skilled in the art. As such, the invention is not to be limited to the described embodiments except as required by the appended claims.

I claim:

1. A sensing system comprising:
(a) a fiber optic light signal source for introducing an optical test signal into a sensing optical fiber;
(b) a fiber optic receiver for receiving light conducted by the sensing optical fiber; and
(c) one or more sensing regions distributed along the sensing optical fiber, each sensing region sensing selected phenomena by affecting a quantity of light of particular wavelengths issuing from the sensing optical fiber into the fiber optic receiver.

2. The sensing system of claim 1, wherein at least one sensing region senses material contacting the sensing region.

3. The sensing system of claim 2, wherein the sensed material is a molding resin.

4. The sensing system of claim 3, wherein the sensing optical fiber is disposed in a mold.

5. The radiation sensing system of claim 1 further comprising an optical light source for directing light into the sensing optical fiber, wherein at least one sensing region is a dose sensing region having an optical fiber core coated with a material whose optical properties change with cumulative exposure to radiation such that cumulative radiation exposure of the dose sensing region can be determined by measuring light transmission losses from the optical light source to the optical receiver along the sensing optical fiber.

6. The radiation sensing system of claim 5, wherein said core fiber is fabricated of silica.

7. The radiation sensing system of claim 5, wherein said core fiber comprises one or more of radiation sensitive material, dopants, F-centers and color centers.

8. The radiation sensing system of claim 7, wherein said dopants comprise trivalent ions of terbium, europium, erbium and praseodymium.

9. The radiation sensing system of claim 1, wherein said sensing regions comprise a radiation sensing region.

10. The radiation sensing system of claim 9, wherein said radiation sensing region comprises a core coated with alkali metal halides.

11. The radiation sensing system of claim 10, wherein said halides comprise chlorides of any alkali metal, bromides and iodides of any alkali metal except lithium, and fluorides of lithium, potassium and sodium.

12. A method for sensing radiation comprising steps of:
(a) providing an optical fiber having a length;
(b) disposing, at one or more locations along the length of said fiber, one or more radiation responsive elements;
(c) analyzing an optical response of said optical fiber at a plurality of light frequencies;
(d) determining a contribution by each of said plurality of radiation responsive elements to the optical response of said optical fiber; and
(e) calculating, from each determined contribution, a quantity of radiation incident upon each of said radiation responsive elements.

13. A method of sensing a flow of material onto an optical fiber core by measuring fiber light transmission losses through the optical fiber core.

14. A method of sensing phenomena comprising steps of:
(a) providing a sensing optical fiber having one or more sensing regions distributed therealong which each sensing region responds to a particular phenomenon by varying light which escapes from the sensing optical fiber; and
(b) determining a condition of said particular phenomenon by observing a quantity and color of light escaping generally laterally from a side of the sensing optical fiber.

15. The sensing method of claim 14 including a further step of introducing an optical test signal into the sensing optical fiber.

16. The sensing method of claim 14 including a further step of introducing an optical test signal into the sensing optical fiber, wherein one of said particular phenomena is a cumulative dose of radiation absorbed by a sensing region.

17. The sensing method of claim 14 including a step of measuring transmission losses at one or more frequencies to distinguish the effects of different phenomena on the sensing optical fiber.

18. The method as claimed in claim 15, wherein one of said particular phenomena is contact of the sensing region by a material.

19. A radiation sensor assembly comprising:
(a) an optical fiber having a length;
(b) electronics to sense the optical response of said optical fiber at one or more light wavelengths; and
(c) one or more radiation responsive elements selected from the group including:
(c1) doped lengths of optical fiber;
(c2) radiochromic inserts embedded in an optical fiber; and
(c3) doped sol gel glass coated on the core of an optical fiber,
wherein each of said plurality of radiation responsive elements is disposed within said optical fiber at a different point along the length of said optical fiber.

20. The radiation sensor assembly of claim 19 wherein each of the plurality of radiation responsive elements responds to a different range of wavelengths of radiation incident thereupon.
